(19) United States
(12) Patent Application Publication
(10) Pub. No.: US 2026/0227034 A1
(43) Pub. Date: Aug. 6, 2026

(54) TANK SYSTEM AND METHOD FOR MONITORING A TIGHTNESS OF A TANK SYSTEM

(71) Applicant: Robert Bosch GmbH, Stuttgart (DE)

(72) Inventors: Christian Kuhnert, Vaihingen/Enz (DE); Markus Strasser, Stuttgart (DE); Martin Schwab, Sindelfingen (DE); Stefan Kieferle, Stuttgart (DE)

(21) Appl. No.: 19/149,425

(22) PCT Filed: Dec. 27, 2023
(86) PCT No.: PCT/EP2023/087849

§ 371 Date: Jul. 18, 2025

(30) Foreign Application Priority Data
Jan. 20, 2023 (DE) 10 2023 200 437.2

(51) Int. Cl. F17C 13/02; F17C 13/12

(52) U.S. Cl. CPC F17C 13/023; F17C 13/025; F17C 13/026; F17C 13/12; F17C 2205/0326; F17C 2205/0338; F17C 2221/012; F17C 2223/0123; F17C 2227/04; F17C 2250/032; F17C 2250/036; F17C 2250/043; F17C 2250/0439; F17C 2250/0615; F17C 2250/0636; F17C 2260/038; F17C 2270/0184

(57) ABSTRACT

The invention presented relates to a tank system (100) for supplying a fluid to a consumer (115), wherein the tank system (100) comprises:
at least one tank (101),
a system separation valve (107),
a mechanically controlled pressure regulator (111),
wherein the system separation valve (107) is connected to the pressure regulator (111) via a system line (113) in a fluid-conducting manner,
wherein the at least one tank (101) comprises a tank valve (103),
wherein the tank valve (103) is connected to the system separation valve (107) via a tank line (109) in a fluid-conducting manner,
a tank line sensor (109) arranged on the tank line (105),
a system line sensor (117) arranged on the system line (113), and
a computing unit (119),

### BACKGROUND

The presented invention relates to a tank system, a fuel cell system and a method for monitoring a tightness of a tank system.

Tank systems with high-pressure accumulators, such as those used to supply a fuel cell system with hydrogen, usually comprise a system separation valve that separates a high-pressure area of a respective tank system from a medium-pressure area.

A mechanical pressure regulator is arranged between the system separation valve and the consumer in order to set a pressure at which fluid is supplied to the consumer from a respective high-pressure accumulator.

In order to use the system separation valve as a redundant shut-off valve, it is necessary to monitor the tightness of the system separation valve.

### SUMMARY

The invention relates to a tank system, a fuel cell system, and a method for monitoring the tightness of a tank system. Further features and details of the invention arise from the respective dependent claims, the description, and the drawings. The features and details described in connection with the method according to the invention naturally also apply in connection with the tank system according to the invention or the fuel cell system according to the invention and vice versa, so that mutual reference can always be made to the disclosure of the individual aspects of the invention.

The invention presented serves in particular to provide a reliable tank system.

Thus, according to a first aspect of the invention presented, a tank system for supplying a consumer with a fluid is presented.

The tank system presented comprises at least one tank, a system separation valve, a mechanically controlled pressure regulator, wherein the system separation valve is connected to the pressure regulator in a fluid-conducting manner via an intermediate line, wherein the at least one tank comprises a tank valve, wherein the tank valve is connected to the system separation valve in a fluid-conducting manner via a tank line, and a computing unit.

The computing unit is electrically connected to the tank valve and the system separation valve and is configured to first close the tank valve of the at least one tank in a first step while fluid is flowing from the tank system to the consumer and then close the system separation valve in a second step, so that a tank pressure in the at least one tank is greater than a tank line pressure in the tank line and the tank line pressure is greater than a system line pressure in the system line, and the pressure regulator opens in order to connect an intermediate line in the intermediate region between the system separation valve and the pressure regulator to a supply line between the pressure regulator and the consumer in a fluid-conducting manner.

The computing unit is further configured to use a first tank line temperature determined at a first instant and a pressure in the tank line to infer a first fluid mass in an area upstream of the system separation valve at the first instant, and to use a system line temperature determined at the first instant and a pressure in the system line to infer a first fluid mass in an area downstream of the system separation valve at the first instant.

The computing unit is further configured to, based on a second tank line temperature determined at a second instant and a pressure in the tank line, to infer a second fluid mass in the region upstream of the system separation valve at the second instant, and based on a second system line temperature determined at the second instant and a pressure in the system line, to infer a second fluid mass in the region downstream of the system separation valve at the second instant, and, on the basis of a change in the first fluid mass in the region upstream of the system separation valve relative to the second fluid mass in the region upstream of the system separation valve and/or a change in the first fluid mass in the region downstream of the system separation valve relative to the second fluid mass in the region downstream of the system separation valve, to monitor the tightness of the tank system.

In the context of the invention presented here, a computing unit is understood to mean a computer, a processor, a sub-processor, a control device, or any other programmable circuit.

In the context of the invention presented, an area upstream of the system separation valve is to be understood as an area arranged upstream of the system separation valve in the direction of flow of fluid flowing out of the tank, in particular an area between the tank and the system separation valve. Accordingly, an area downstream of the system separation valve in the context of the invention presented is to be understood as an area arranged downstream of the system separation valve in the direction of flow of fluid flowing out of the tank, in particular an area between the system separation valve and the consumer.

A second instant in the context of the invention presented is to be understood as a time after a first instant.

The invention presented is based on a tank system comprising electrically controlled valves, namely a tank valve of a respective tank and a system separation valve. Accordingly, the tank valve or tank valves and the system separation valve can be controlled or regulated by the computer unit provided according to the invention. For this purpose, the valves are connected to the computer unit via a wired interface, for example.

To monitor the tightness of the tank system presented, the computer unit carries out a process in which, while a consumer draws or delivers fluid from the tank system, the tank valve is first closed in a first step, so that a pressure difference is created in a tank line between the tank and the consumer or the system separation valve, since fluid mass is removed from the tank line by the consumer and the pressure in the tank line is reduced.

Subsequently, i.e. after the first step, the system separation valve is closed in a second step, so that a pressure difference is created between an area upstream of the system separation valve and an area downstream of the system separation valve, since fluid mass is removed from the area downstream of the system separation valve by the consumer and the pressure in the area downstream of the system separation valve is reduced. Accordingly, after the second step, a state is reached in the tank system in which a tank pressure in the tank is greater than a tank line pressure in the tank line and the tank line pressure is greater than a system line pressure in a system line in the area downstream of the system separation valve, and the pressure regulator opens in order to connect an intermediate line in the intermediate region between the system separation valve and the pressure regulator to a supply line between the pressure regulator and the consumer in a fluid-conducting manner. This means that the second step keeps the pressure regulator open even after the consumer has been switched off or deactivated.

By carrying out the first step and the second step, different pressures are set in the tank system at least in the area upstream of the system separation valve and downstream of the system separation valve and the areas are separated from each other. Accordingly, a pressure curve in the area upstream of the system separation valve can be evaluated independently of a pressure curve in the area downstream of the system separation valve if the system separation valve closes correctly or is tight.

In order to monitor the tightness of the tank system over time, it is provided that by means of the tank line sensor arranged in the area upstream of the system separation valve at a first instant, in particular after deactivation of the consumer, a pressure is determined in the area upstream of the system separation valve and the pressure is used to infer a first fluid mass in the area upstream of the system separation valve at the first instant and the first fluid mass in the area upstream of the system separation valve is compared with a second fluid mass in the area upstream of the system separation valve, which is determined by means of a pressure determined by the tank line sensor at a second instant.

It may be provided that the computing unit is configured to mathematically correlate measured values determined by the tank line sensor with a temperature in the tank system and a predetermined volume of the area upstream of the system separation valve in order to determine a fluid mass in the area upstream of the system separation valve and to mathematically correlate measured values determined by the system line sensor with a temperature in the tank system and a predetermined volume of the area downstream of the system separation valve in order to determine a fluid mass in the area downstream of the system separation valve.

To determine the temperature in the tank system, a temperature sensor in the tank system, in particular in a respective tank or an environment of the tank system and/or a mathematical model of the tank system can be used.

By comparing the first fluid mass in the area upstream of the system separation valve with the second fluid mass in the area upstream of the system separation valve, a change in the fluid mass in the area upstream of the system separation valve can be inferred over time, so that a leak in the area upstream of the system separation valve can be reliably detected if, for example, the second fluid mass in the area upstream of the system separation valve is smaller than the first fluid mass in the area upstream of the system separation valve.

By comparing the second fluid mass in the area downstream of the system separation valve with the first fluid mass in the area downstream of the system separation valve, a change in the fluid mass in the area downstream of the system separation valve can be inferred over time, so that a leak in the area downstream of the system separation valve can be reliably detected if, for example, the second fluid mass in the area downstream of the system separation valve is smaller than the first fluid mass in the area downstream of the system separation valve.

It may be provided that the computing unit is configured to output an error message indicating a leakage of the system separation valve in the event that a decrease in the second fluid mass in the region upstream of the system separation valve relative to the first fluid mass in the region upstream of the system separation valve occurs in conjunction with an increase in the second fluid mass in the region downstream of the system separation valve relative to the first fluid mass in the region downstream of the system separation valve.

With an increase in the second fluid mass in the area downstream of the system separation valve and a simultaneous decrease in the second fluid mass in the area upstream of the system separation valve, it can be assumed that fluid has migrated in the direction of a pressure gradient from the area upstream of the system separation valve, through the system separation valve, into the area downstream of the system separation valve. Accordingly, it can be concluded that the system separation valve is leaking or faulty and a corresponding error message is issued.

It may further be provided that the computing unit is configured to output an error message indicating a leakage in the region between the tank valve and the system separation valve in the event that a decrease in the second fluid mass occurs in the region upstream of the system separation valve relative to the first fluid mass in the region upstream of the system separation valve in conjunction with no increase in the second fluid mass in the region downstream of the system separation valve relative to the first fluid mass in the region downstream of the system separation valve.

It may further be provided that the computing unit is configured to output an error message indicating a leakage in an area upstream of the system separation valve, in particular of at least one tank valve, in the event that the second fluid mass in the area upstream of the system separation valve is greater than the first fluid mass in the area upstream of the system separation valve.

If the second fluid mass in the area upstream of the system separation valve increases compared to the first fluid mass in the area upstream of the system separation valve, i.e. if the fluid mass in the area upstream of the system separation valve, in particular in the tank line, increases over time, it can be assumed that fluid is flowing from the tank into the area upstream of the system separation valve or into the tank line, which must result from at least one leaking tank valve.

To output an error message, the computing unit can, for example, store the error message in a memory, such as an error memory, and/or transmit the error message to a display, such as a display of a consumer supplied with fluid by the tank system.

It may further be provided that the computing unit is configured to output a plausibility check message indicating a tightness of the tank system in the event that the first fluid mass in the region upstream of the system separation valve is equal to the second fluid mass in the region upstream of the system separation valve and the first fluid mass in the region downstream of the system separation valve is equal to the second fluid mass in the region downstream of the system separation valve.

In the event that all fluid masses are or remain constant over time, it can be assumed that there is no leakage in the tank system so that a plausibility check message can be output.

It may further be provided that the computing unit comprises an interface for communicating with the consumer and the computing unit is configured to receive a deactivation command for deactivating the consumer from the consumer and to select an instant for closing the tank valve in response to the deactivation command or to receive an instant for closing the tank valve from the consumer.

In order to utilize a controlled pressure drop in the tank system presented and to set different pressure ranges in the tank system, a consumer must be in a state in which it delivers fluid from the tank system but is not disturbed in its function by closing the tank valve and the system separation valve. Such a state occurs when the consumer is deactivated, so that the instant for closing the tank valve can be selected depending on a deactivation command for deactivating the consumer, e.g. at a predefined time range after the deactivation command.

An instant for closing the system separation valve can be selected accordingly depending on the time for closing the tank valve and/or depending on the deactivation command and can correspond to a predetermined time range after the instant for closing the tank valve.

It may further be provided that the computing unit is configured to receive information about a fluid consumption expected by the consumer from the consumer and to select the instant for closing the system separation valve in response to the expected fluid consumption such that the consumer lowers a pressure in the area downstream of the system separation valve and opens the pressure regulator.

In order to use a fluid consumption of a respective consumer to reduce a pressure in the area downstream of the system separation valve, a state in which the system separation valve is closed and the consumer no longer draws fluid should be avoided. Accordingly, the instant at which the system separation valve is closed can be selected such that a residual quantity that the consumer still withdraws before deactivating the withdrawal of fluid corresponds to a fluid mass that is located in the area downstream of the system separation valve and upstream of the consumer.

It may further be provided that the tank system is a pressurized hydrogen tank system and the at least one tank is a pressurized hydrogen tank.

It may further be provided that the computing unit is configured to ascertain the tank line temperature in the tank line by means of a tank line temperature sensor and/or a mathematical model for ascertaining the tank line temperature and/or to ascertain the system line temperature in the system line by means of a system line temperature sensor and/or a mathematical model for determining the system line temperature.

According to a second aspect, the presented invention relates to a fuel cell system.

The fuel cell system presented comprises a possible embodiment of the tank system presented, whereby a control device of the fuel cell system is communicatively connected to the computing unit of the tank system.

In particular, the computing unit of the tank system can be configured to output error messages and/or plausibility check messages on a display of the fuel cell system.

According to a third aspect, the invention presented relates to a method for monitoring the tightness of a tank system.

The method presented comprises closing a tank valve of at least one tank of the tank system while fluid is flowing from the tank system to a consumer, closing a system separation valve after the tank valve has been closed so that a tank pressure in the at least one tank is greater than a tank line pressure in a tank line between the at least one tank and the system separation valve and the tank line pressure is greater than a system line pressure in a system line in the region downstream of the system separation valve, and a pressure regulator between the system separation valve and a consumer opens, in order to connect an intermediate line in the intermediate region between the system separation valve and the pressure regulator to a supply line between the pressure regulator and the consumer in a fluid-conducting manner, determining a first fluid mass in the region upstream of the system separation valve at a first instant of a first upstream temperature determined for the region upstream of the system separation valve at the first instant, determining a second fluid mass in the region upstream of the system separation valve at a second instant of a second upstream temperature determined for the region upstream of the system separation valve at the second instant,
determining a first fluid mass in the region downstream of the system separation valve at a first instant on the basis of a first downstream temperature determined for the region downstream of the system separation valve at the first instant, determining a second fluid mass in the region downstream of the system separation valve at a second instant on the basis of a second downstream temperature determined for the region downstream of the system separation valve at the second instant, monitoring a tightness of the tank system on the basis of a change in the first fluid mass in the region upstream of the system separation valve compared with the second fluid mass in the region upstream of the system separation valve and/or a change in the first fluid mass in the region downstream of the system separation valve compared with the second fluid mass in the region downstream of the system separation valve.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

The following is shown:

FIG. 1 a schematic illustration of a possible embodiment of the tank system presented,

FIG. 2 a schematic illustration of one possible embodiment of the presented fuel cell system,

FIG. 3 an illustration of a possible embodiment of the method presented.

### DETAILED DESCRIPTION

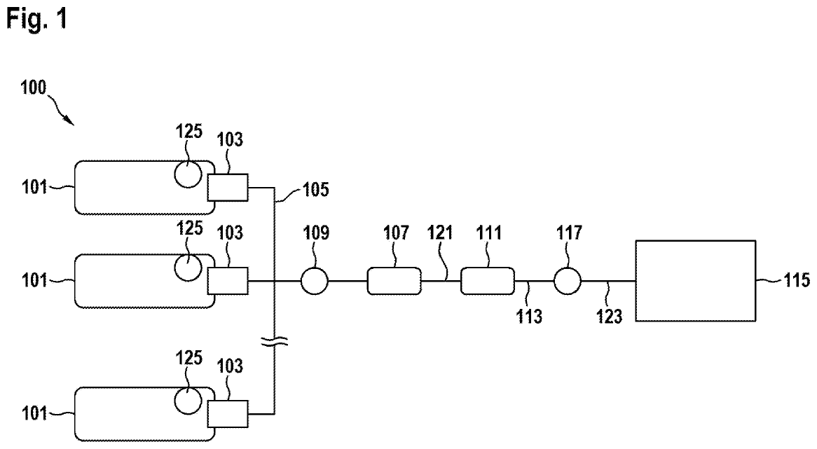

FIG. 1 shows a tank system 100. The tank system 100 comprises a plurality of tanks 101, each of which comprises a tank valve 103.

The tanks 101 and the tank valves 103 are connected to a system separation valve 107 via a tank line 105 in a fluid-conducting manner.

A tank line sensor 109 is arranged on the tank line 105, which is configured to detect a pressure and optionally also a temperature in the tank line 105.

Accordingly, the tanks 101, the tank valves 103, the tank line 105 and the tank line sensor 109 form an area upstream of the system separation valve 107.

A pressure regulator 111 is arranged in an area downstream of the system separation valve 107, which adjusts a pressure of a system line 113 for supplying a consumer 115.

A system line sensor 117 is arranged on the system line 113, which is configured to detect a pressure and optionally also a temperature in the system line 113.

Further, the tank system 100 comprises a computing unit 119 configured to, in a first step, first close the tank valves 103 while fluid is flowing from the tank system 100 to the consumer 115 and, in a second step, subsequently close the system isolation valve 107, so that a tank pressure in a respective tank 101 is greater than a tank line pressure in the tank line 105 and the tank line pressure is greater than a system line pressure in the system line 113, and the pressure regulator 111 opens in order to connect an intermediate line 121 in the intermediate region between the system separation valve 107 and the pressure regulator 111 to a supply line 123 between the pressure regulator 111 and the consumer 115 in a fluid-conducting manner.

Furthermore, the computing unit 119 is configured to infer a first fluid mass in the area upstream of the system separation valve 107 at the first instant based on measured values determined by the tank line sensor 109 at a first instant and a first fluid mass in the area downstream of the system separation valve 107 at the first instant based on measured values determined by the system line sensor 117 at the first instant and to infer a second fluid mass in the area upstream of the system separation valve 107 at the second instant based on measured values determined by the tank line sensor 109 at a second instant and a second fluid mass in the area downstream of the system separation valve 107 at the second instant based on measured values determined by the system line sensor 117 at the second instant, and to infer a second fluid mass in the area downstream of the system separation valve 107 at the second instant based on a change in the first fluid mass in the area upstream of the system separation valve 107 compared to the second fluid mass in the area upstream of the system separation valve 107 and/or a change in the first fluid mass in the area downstream of the System separation valve 107 compared to the second fluid mass in the area downstream of the system separation valve 107 to monitor the tightness of the tank system 101 with respect to the second fluid mass in the area after the system separation valve 107.

Optionally, temperature sensors 125 are arranged on the tanks 101 in order to detect a temperature of a fluid, i.e. in particular hydrogen, stored in a respective tank 101 and to calculate a fluid mass present in the region upstream of the system separation valve 107 and/or in the region downstream of the system separation valve 107. For this purpose, values determined by the temperature sensors 125, for example, can be fed into a mathematical model of the tank system 100.

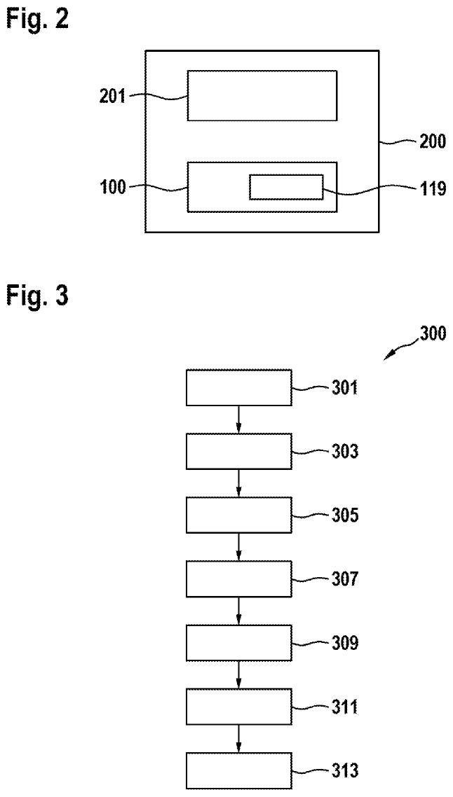

FIG. 2 shows a fuel cell system 200. The fuel cell system 200 comprises the tank system 100 as shown in FIG. 1 and a control device 201, which is communicatively connected to the computing unit 119 of the tank system 100.

FIG. 3 shows method 300 for monitoring the tightness of a tank system.

The method 300 comprises a first closing step 301 in which a tank valve of at least one tank of the tank system is closed while fluid is flowing from the tank system to a consumer, a second closing step 303 in which a system separation valve is closed after the tank valve has been closed, so that a tank pressure in the at least one tank is greater than a tank line pressure in a tank line between the at least one tank and the system separation valve and the tank line pressure is greater than a system line pressure in a system line in the region downstream of the system separation valve, and a pressure regulator between the system separation valve and a consumer opens to connect an intermediate line in the intermediate region between the system separation valve and the pressure regulator to a supply line between the pressure regulator and the consumer in a fluid-conducting manner.

Furthermore, the method 300 comprises a first determination step 305, in which a first fluid mass in the region upstream of the system separation valve is determined at a first instant using measured values determined by a tank line sensor arranged in the region upstream of the system separation valve at the first instant and a pressure in the region upstream of the system separation valve, a second determination step 307, in which a second fluid mass in the region upstream of the system separation valve is determined at a second instant on the basis of measured values determined by the tank line sensor at the second instant and a pressure in the region upstream of the system separation valve, a third determination step 309, in which a first fluid mass in the region downstream of the system separation valve is determined at a first instant on the basis of measured values determined by a system line sensor arranged in the region downstream of the system separation valve and a pressure in the region downstream of the system separation valve at the first instant, a fourth determination step 311, in which a second fluid mass in the region downstream of the system separation valve is determined at a second instant on the basis of measured values determined by the system line sensor at the second instant and a pressure in the region downstream of the system separation valve, and a monitoring step 313, in which a tightness of the tank system is monitored on the basis of a change in the first fluid mass in the region upstream of the system separation valve with respect to the second fluid mass in the region upstream of the system separation valve and/or a change in the first fluid mass in the region downstream of the system separation valve with respect to the second fluid mass in the region downstream of the system separation valve.

In particular, the third determination step 309 is performed in parallel with or immediately after the first determination step 305.

In particular, the fourth determination step 311 is performed in parallel with or immediately after the second determination step 307.

1. A tank system (100) for supplying a fluid to a consumer (115), wherein the tank system (100) comprises:
at least one tank (101),
a mechanically controlled pressure regulator (111),
a system separation valve (107),
wherein the system separation valve (107) is connected to the pressure regulator (111) via an intermediate line (121) in a fluid-conducting manner,
wherein the at least one tank (101) comprises a tank valve (103),
wherein the tank valve (103) is connected to the system separation valve (107) via a tank line (105) in a fluid-conducting manner,
a computing unit (119),
wherein the computing unit (119) is electrically connected to the tank valve (103) and the system separation valve (107),
wherein the computing unit (119) is configured
in a first step, while fluid flows from the tank system (100) to the consumer (115), to first close the tank valve (103) of the at least one tank (101), and
in a second step, to close the system separation valve (107) so that a tank pressure in the at least one tank (101) is greater than a tank line pressure in the tank line (105) and the tank line pressure is greater than a system line pressure in the system line (113), and the pressure regulator (111) opens to connect the intermediate line (121) in an intermediate region between the system separation valve (107) and the pressure regulator (111) to a supply line (123) between the pressure regulator (111) and the consumer (115) in a fluid-conducting manner, and
wherein the computing unit (119) is further configured
to infer a first fluid mass in a region upstream of the system separation valve (107) at a first instant based on a first tank line temperature determined at the first instant and a pressure in the tank line (105) and to infer a first fluid mass in a region downstream of the system separation valve (107) at the first instant based on a first system line temperature determined at the first instant and a pressure in the system line (113),
wherein the computing unit (119) is further configured
to infer a second fluid mass in the region upstream of the system separation valve (107) at the second instant based on a second tank line temperature determined at a second instant and a pressure in the tank line, and to infer a second fluid mass in the region downstream of the system separation valve (107) at the second instant based on a second system line temperature determined at the second instant and a pressure in the system line (113),
to monitor a tightness of the tank system (100) based on a change in the first fluid mass in an area upstream of the system separation valve (107) compared to the second fluid mass in the area upstream of the system separation valve (107) and/or a change in the first fluid mass in the area downstream of the system separation valve (107) compared to the second fluid mass in the area downstream of the system separation valve (107).

2. The tank system (100) according to claim 1,
wherein
the computing unit (119) is configured such that, when a decrease in the second fluid mass in the region upstream of the system separation valve (107) relative to the first fluid mass in the region upstream of the system separation valve (107) occurs in conjunction with an increase in the second fluid mass in the region downstream of the system separation valve (107) in the region downstream of the system separation valve (107) relative to the first fluid mass in the region after the system separation valve (107), to output an error message indicating a leakage of the system separation valve (107).

3. The tank system (100) according to claim 1,
wherein
the computing unit (119) is configured, when a decrease in the second fluid mass in the region upstream of the system separation valve (107) relative to the first fluid mass in the region upstream of the system separation valve (107) in conjunction with no increase in the second fluid mass in the region downstream of the system separation valve (107) in the region after the system separation valve (107) relative to the first fluid mass in the region after the system separation valve (107), to output an error message indicating a leak in the region between the tank valve (103) and the system separation valve (107).

4. A tank system (100) according to claim 1,
wherein
the computing unit (119) is configured, when the second fluid mass in the region upstream of the system separation valve (107) is greater than the first fluid mass in the region upstream of the system separation valve (107), to output an error message indicating a leak of at least one tank valve (103) into the region upstream of the system separation valve (107).

5. A tank system (100) according to claim 1,
wherein
the computing unit (119) is configured such that, when the second fluid mass in the region downstream of the system separation valve (107) is smaller than the first fluid mass in the region downstream of the system separation valve (107),
an error message is output indicating a leak in the region downstream of the system separation valve (107).

6. A tank system (100) according to claim 1,
wherein
the computing unit (119) is configured to output a plausibility check message indicating a tightness of the tank system (100) when the first fluid mass in the region upstream of the system separation valve (107) is equal to the second fluid mass in the region upstream of the system separation valve (107) and the first fluid mass in the region downstream of the system separation valve (107) is equal to the second fluid mass in the region downstream of the system separation valve (107).

7. A tank system (100) according to claim 1,
wherein the computing unit (119) is configured to mathematically correlate measured values determined by a tank line sensor (109) with a temperature in the tank system (100) and a predetermined volume of the region upstream of the system separation valve (107), in order to determine a fluid mass in the region upstream of the system separation valve (107), and to mathematically correlate measured values determined by the system line sensor (117) to a temperature in the tank system (100) and a predetermined volume of the region downstream of the system separation valve (107) in order to determine a fluid mass in the region downstream of the system separation valve (107).

8. A tank system (100) according to claim 1,
wherein
the computing unit (119) comprises an interface for communicating with the consumer (115), and the computing unit (119) is configured to receive
a deactivation command for deactivating the consumer (115) from the consumer (115) and/or to select an instant for closing the tank valve (103) in response to the deactivation command or to receive an instant for closing the tank valve (103) from the consumer (115).

9. A tank system (100) according to claim 1,
wherein
the computing unit (119) is configured to receive information about a fluid consumption expected by the consumer (115) from the consumer (115) and to select an instant for closing the system separation valve (107) in response to the expected fluid consumption such that the consumer (115) reduces a pressure in the region downstream of the system separation valve (107) and opens the pressure regulator (111).

10. A tank system (100) according to claim 1,
wherein
the tank system (100) is a pressurized hydrogen tank system and the at least one tank (101) is a pressurized hydrogen tank.

11. A tank system (100) according to claim 1,
wherein
the computing unit is configured to determine the tank line temperature in the tank line (105) by means of a tank line temperature sensor and/or a mathematical model for determining the tank line temperature, and/or
to determine the system line temperature in the system line (113) by means of a system line temperature sensor and/or a mathematical model for determining the system line temperature.

12. A fuel cell system (200) for converting energy,
wherein the fuel cell system (200) comprises a tank system (100) according to claim 1, and wherein a control device (201) of the fuel cell system (200) is communicatively connected to the computing unit (119) of the tank system (100).

13. A method (300) for monitoring a tightness of a tank system (100), wherein the method (300) comprises:
closing (301) a tank valve (103) of at least one tank (101) of the tank system (100) while fluid is flowing from the tank system (100) to a consumer (115),
closing (303) a system separation valve (107) after the tank valve (103) has been closed, so that a tank pressure in the at least one tank (101) is greater than a tank line pressure in a tank line (105) between the at least one tank (101) and the system separation valve (107) and the tank line pressure is greater than a system line pressure in a system line (113) in a region downstream of the system separation valve (107), and a pressure regulator (111) between the system separation valve (107) and a consumer (115) opens in order to connect an intermediate line (121) in the intermediate region between the system separation valve (107) and the pressure regulator (111) to a supply line (123) between the pressure regulator (111) and the consumer (115) in a fluid-conducting manner,
determining (305) a first fluid mass in the region upstream of the system separation valve (107) at a first instant based on a first upstream temperature determined for the region upstream of the system separation valve (107) at the first instant and a pressure in the region upstream of the system separation valve,
determining (307) a second fluid mass in a region upstream of the system separation valve (107) at a second instant of a second upstream temperature determined for the region upstream of the system separation valve (107) at the second instant and a pressure in the region upstream of the system separation valve,
determining (309) a first fluid mass in the region downstream of the system separation valve (107) at a first instant based on a first downstream temperature determined for the region downstream of the system separation valve (107) at the first instant and a pressure in the region downstream of the system separation valve,
determining (311) a second fluid mass in the region downstream of the system separation valve (107) at a second instant based on a second downstream temperature determined for the region downstream of the system separation valve (107) at the second instant and a pressure in the region upstream of the system separation valve, and
monitoring (313) a tightness of the tank system (100) based on a change in the first fluid mass in an area upstream of the system separation valve (107) compared to the second fluid mass in the area upstream of the system separation valve (107) and/or a change in the first fluid mass in an area downstream of the system separation valve (107) compared to the second fluid mass in the area downstream of the system separation valve (107).
